(19) United States
(12) Patent Application Publication
(10) Pub. No.: US 2009/0116184 A1
(43) Pub. Date: May 7, 2009

(54) Exclusive protection device for PCMCIA card/express card

(75) Inventor: Yau-Ren Jenq, Taipei (TW)

Correspondence Address: BIRCH STEWART KOLASCH & BIRCH, PO BOX 747, FALLS CHURCH, VA, 22040-0747, US

(73) Assignees: GIGA-BYTE Communications Inc.; GIGA-BYTE TECHNOLOGY CO., LTD.

(21) Appl. No.: 12/285,278

(22) Filed: Oct. 1, 2008

(30) Foreign Application Priority Data
Nov. 5, 2007 (TW) 096141764

(51) Int. Cl. G06F 1/16

(52) U.S. Cl. 361/679.56

(57) ABSTRACT

An exclusive protection device for a PCMCIA card/express card, includes a shell, a liquid crystal display and a control unit. The inner surface of the shell defines a slot and the outer surface defines a chamber. The slot is disposed to receive a PCMCIA card or an express card. The liquid crystal display is fixed in the chamber of the shell. The control unit is disposed in the shell and connected to the liquid crystal display. Accordingly, not only can this protection device provides protection for the PCMCIA card/express card, but it also possesses many additional functions, such as a display function, a broadcast function, a transfer function and a telephone communication function.

### CROSS-REFERENCE TO RELATED APPLICATIONS

This nonprovisional application claims priority under 35 U.S.C. §119(a) on Patent Application No. 096141764 filed in Taiwan on Nov. 5, 2007, the entirety of which is incorporated herein by reference.

### BACKGROUND OF THE INVENTION

1. Field of the Invention

The present invention relates to a PCMCIA card/Express card, and more particularly to an exclusive protection device for a PCMCIA card/express card.

2. Background of the Invention

A card adaptor for an Express card is disclosed in Taiwanese Patent No. M270422, which only has a transfer function but does not a have protection function or any other functions. That is, when an express card is inserted into the card adaptor, it becomes a PCMCIA card without any protection.

An ordinary protection device for wireless network interface card is disclosed in Taiwanese Patent No. M309814, which comprises a card slot for receiving a wireless network interface card, and a USB interface for connecting a computer. This device provides both the protection and transfer functions. However, there is not any other function provided in this device.

### SUMMARY OF THE INVENTION

The present invention provides an exclusive protection device, with a display function, for PCMCIA card/express card.

In detail, the protection device of the present invention comprises a shell, a liquid crystal display and a control unit. The inner surface of the shell defines a slot and the outer surface defines a chamber. The slot is disposed to receive a PCMCIA card or an Express card. The liquid crystal display is fixed in the chamber of the shell. The control unit is disposed in the shell, and connected to the liquid crystal display.

The protection device of the present invention also comprises an interface transfer unit in the shell, which is disposed to connect a USB port outside and the PCMCIA/express card inside, for transferring signals between the PCMCIA/express card and the USB port.

According to the present invention, the protection device comprises a speaker, a keyboard input unit and a microphone, and all of those are connected with the control unit. The control unit is disposed to connect a PCMCIA card/express card. Then a function of a communicating device can be fulfilled by cooperating with the speaker, the keyboard input unit, the microphone, the liquid crystal display, and the PCMCIA card/express card.

Accordingly, not only can this protection device provide protection for the PCMCIA card/Express card, but it also possesses many additional functions, such as a display function, a broadcast function, a transfer function and a telephone communication function.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a tridimensional exploded view of a first embodiment according to the present invention;

FIG. 2 is a tridimensional folded view of the first embodiment according to the present invention;

FIG. 3 is a block diagram of the system of a second embodiment according to the present invention; and

FIG. 4 is a block diagram of the system of a third embodiment according to the present invention.

### DETAILED DESCRIPTION OF THE ILLUSTRATED EMBODIMENTS

The present invention will now be described in detail with reference to the accompanying drawings, wherein the same reference numerals will be used to identify the same or similar elements throughout the several views. It should be noted that the drawings should be viewed in the direction of orientation of the reference numerals.

In the following description, a PCMCIA card generally refers to a computer peripheral device applying the PCMCIA interface protocol, such as a PCMCIA memory card, a PCMCIA 3G wireless network card, a PCMCIA card adaptor which transfers the memory card interface to PCMCIA interface, etc. The express card generally refers to a computer peripheral device applying the express interface protocol, such as an express memory card, an express 3G wireless network card, an express memory card adaptor, etc.

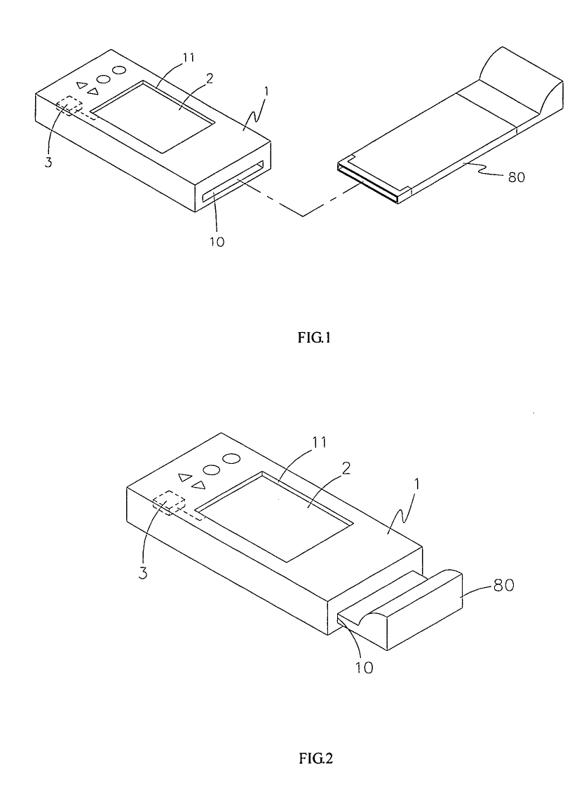

FIG. 1 and FIG. 2 illustrate an exclusive protection device for an Express card 80 in accordance with the first embodiment according to the present invention. The protection device includes a shell 1, a liquid crystal display 2 and a control unit 3. The inner surface of the shell 1 defines a slot 10 and the outer surface of the shell 1 defines a chamber 11. The slot 10 is disposed to receive the express card 80, and allows the shell 1 to receive and protect the express card 80. The liquid crystal display 2 is fixed in the chamber 11 of the shell 1. The control unit 3 is fixed in the shell 1, and connected with the liquid crystal display 2 for controlling the liquid crystal display 2 to fulfill the display function.

The control unit 3 can also be disposed to control the liquid crystal display 2 to fulfill other electronic functions, such as displaying date and time, making the protection device a clock or an alarm; displaying photos, making the protection device a digital photo frame; and/or displaying game interface, making the protection device a game player, which of course should be fulfilled by cooperating with a keyboard input unit 6 and a speaker 5, which will be introduced later.

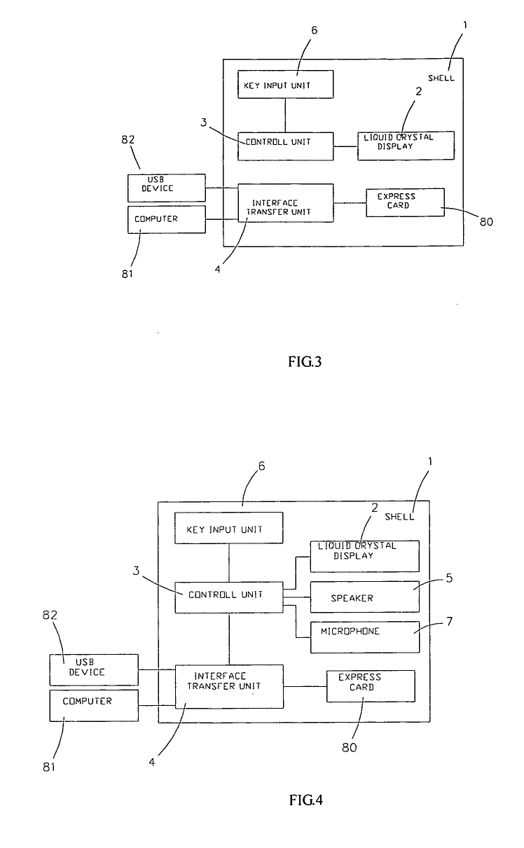

The protection device, shown in FIG. 3, further includes an interface transfer unit 4, which is fixed in the shell 1. The interface transfer unit 4 is disposed to connect a USB port 82 outside and the express card 80 inserted in the shell 1, and to transfer signals between the express card 80 and the USB port 82. The interface transfer unit 4 can convert signals of the Express standards to signals of the USB standards and vice versa. In this embodiment, the interface transfer unit 4 has a USB controller, which possesses a hub function, such as the CY7C66XXX micro-controller produced by Cypress Semiconductor Corporation.

The protection device can further provide a USB interface transfer function and a USB hub function. With the USB interface transfer function, two interfaces of the express card 80 can be used simultaneously, with one of them inserted in the express slot of the computer 81, and the other connected to the USB port of the computer 81 through the protection device. With the USB hub function, the computer 81 could connect more USB device 82.

The USB controller with the hub function, mentioned above, can be replaced by a general USB controller (for example, the CY7C64211 micro-controller produced by Cypress Semiconductor Corporation). In this condition, the interface transfer unit 4 only has the USB interface transfer function.

FIG. 4 shows another embodiment of the present invention. In this embodiment, the protection device further includes a speaker 5, a keyboard input unit 6 and a microphone 7, all of which are disposed on the shell 1, and respectively connected with the control unit 3. The control unit 3 is disposed to connect the express card 80.

The control unit 3 of this example can include an MP3 audio player unit, an MP4 media player unit and a recorder unit. Those functions of MP3, MP4, and recorder, are fulfilled with the speaker for audio output, the liquid crystal display 2 for displaying, and the microphone for recording.

In addition, the express card 80 can also be a mobile communication card with the mobile communication function, which will be fulfilled by cooperating with the speaker 5, the keyboard unit 6, the microphone 7 and the liquid crystal display 2.

According to the illustrated embodiments of the present invention, the protection device can be designed to receive and protect a PCMCIA/express card. The transfer unit 4 is designed to transfer/convert the PCMCIA signals and the USB signals. Moreover, when the PCMCIA/express card is a mobile communication card, the protection device provides a mobile communication function by cooperating with the speaker 5, the keyboard unit 6, the microphone 7 and the liquid crystal display 2.

Accordingly, not only can this protection device protect the PCMCIA card/Express card, but it also possesses a display function and many other additional functions, such as a USB interface transfer function, a USB hub function, a multimedia (MP3, MP4 and recorder) function and a mobile phone communication function.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An exclusive protection device for a PCMCIA card, comprising:
a shell, defining a slot therein for receiving the PCMCIA card, and defining a chamber on an outer surface thereof;
a liquid crystal display fixed in the chamber; and
a control unit disposed in the shell and connected to the liquid crystal display.

2. The exclusive protection device according to claim 1, further comprising:
an interface transfer unit fixed in the shell and connected to a USB port of a computer and the PCMCIA card, for transferring and converting signals between the PCMCIA card and the USB port.

3. The exclusive protection device according to claim 2, wherein the interface transfer unit is connected to at least one USB device outside of the exclusive protection device.

4. The exclusive protection device according to claim 1, further comprising a speaker and a keyboard input unit, both of which are fixed on the shell and connected to the control unit respectively.

5. The exclusive protection device according to claim 4, further comprising a microphone disposed on the shell and connected to the control unit.

6. The exclusive protection device according to claim 5, wherein the control unit is connected to the PCMCIA card, and fulfills a mobile communication function by cooperating with the speaker, the keyboard input unit, the microphone, the liquid crystal display and the PCMCIA card.

7. An exclusive protection device for express card, comprising:
a shell, defining a slot therein for receiving an express card, and defining a chamber on a surface thereof;
a liquid crystal display fixed in the chamber; and
a control unit disposed in the shell and connected to the liquid crystal display.

8. The exclusive protection device according to claim 7, further comprising:
an interface transfer unit fixed in the shell and connected to a USB port of a computer and the express card, for transferring and converting signals between the express card and the USB port.

9. The exclusive protection device according to claim 8, wherein the interface transfer unit is connected to at least one USB device outside of the exclusive protection device.

10. The exclusive protection device according to claim 7, further comprising a speaker and a keyboard input unit, both of which are fixed on the shell and connected to the control unit respectively.

11. The exclusive protection device according to claim 10, further comprising a microphone disposed on the shell and connected to the control unit.

12. The exclusive protection device according to claim 11, wherein the control unit is connected to the express card, and fulfills a mobile communicating function by cooperating with the speaker, the keyboard input unit, the microphone, the liquid crystal display and the express card.
